(19) United States
(12) Patent Application Publication
(10) Pub. No.: US 2026/0129565 A1
(43) Pub. Date: May 7, 2026

(54) METHOD AND APPARATUS FOR SERVICE-AWARE AND APPLICATION-AWARE BAND AND NETWORK SLICING SELECTIONS

(71) Applicants: AT&T Intellectual Property I, L.P., Atlanta, GA (US); AT&T Mobility II LLC, Atlanta, GA (US)

(72) Inventors: Prashant Raghuvanshi, Parker, CO (US); Richard T. Kwapniewski, Middletown, NJ (US)

(73) Assignees: AT&T Intellectual Property I, L.P., Atlanta, GA (US); AT&T Mobility II LLC, Atlanta, GA (US)

(21) Appl. No.: 18/937,681

(22) Filed: Nov. 5, 2024

(51) Int. Cl. H04W 48/18; H04L 45/302; H04L 47/2475; H04W 28/02

(52) U.S. Cl. CPC H04W 48/18; H04L 45/306; H04L 47/2475; H04W 28/0215

(57) ABSTRACT

Aspects of the subject disclosure may include, for example, receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device. Other embodiments are disclosed.

### FIELD OF THE DISCLOSURE

The subject disclosure relates to a method and apparatus for service-aware and application-aware band and network slicing selections.

### BACKGROUND

Different Radio Frequencies (RF) can provide different service characteristics for communication services. Network operators can have access to specific low, mid, and/or high band frequencies. Certain services work well in one RF frequency versus another. As countries develop, they seek to improve or adopt a dedicated public safety mobile network, such as FirstNet in the United States, which has been the frontrunner in expanding the public safety needs and has since been built out as a purpose-built network. Today, if another country were to build the same network, it would need to start from scratch and this will lead to long lead times.

Additionally, in current wireless communication networks, user devices connect to the network by scanning available frequencies based on a predefined priority order. This static priority order results in different services utilizing the same frequency, which can lead to potential congestion and inefficient use of spectrum resources. For example, public safety networks require dedicated frequencies to ensure reliable and low-latency communication for services. Current systems do not differentiate between various types of services when assigning frequencies, causing services to share bandwidth with less important applications. This can degrade the quality of service for particular applications, which require higher priority and dedicated resources.

Further, in current network environments, users access and manage network resources through mobile devices, creating customized network configurations for specific purposes. This capability can lead to more efficient use of network resources, improved performance, and tailored experiences for various applications and services. One existing feature enables the allocation of multiple configurations to a single mobile device and assigns configurations to particular applications based on specific rules. These rules consist of route descriptors such as Data Network Name (DNN) or Operating System specific Application Identifier (OSAppID).

Current policies support providing a specific configuration based on a network connection indicator. This indicator is provided to the mobile OS, which interacts with the network to assign a configuration to a particular application set, such as low latency or high bandwidth application categories. However, this approach has limitations. Many users perform different actions using mobile browsers rather than downloading separate applications for each service. Additionally, a single application with multiple subfunctions or features receives one configuration, which may not be optimal for different features, such as voice, video, and messaging services. Furthermore, current solutions do not address scenarios where users access services through mobile browsers, potentially bypassing network policies intended for specific applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a data flow functioning within the communication network of FIG. 1 in accordance with various aspects described herein.

FIG. 2C is a block diagram illustrating an example, non-limiting embodiment of data flow functioning within the communication network of FIG. 1 in accordance with various aspects described herein.

FIG. 2D is a block diagram illustrating an example, non-limiting embodiment of a system functioning within the communication network of FIG. 1 in accordance with various aspects described herein.

FIG. 2E is a block diagram illustrating an example, non-limiting embodiment of data in an application layer and operating system of an end user device functioning within the communication network of FIG. 1 in accordance with various aspects described herein.

FIG. 2F is a block diagram illustrating an example, non-limiting embodiment of a data flow for UE Route Selection Policy management functioning within the communication network of FIG. 1 in accordance with various aspects described herein.

FIG. 2G depicts an illustrative embodiment of a method in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for dynamically assigning Radio Frequency Selection Priority (RFSP) values based on the type of service being accessed by the user, rather than having a static RF band priority for all services. This approach allows for more efficient use of RF spectrum resources by prioritizing critical services, such as Mission Critical Push-to-Talk (MCPTT), on dedicated bands such as band 14, while routing less critical services, such as video streaming, to other bands such as band 66 or band 77. In one or more embodiments, this dynamic allocation can be applied across multinational and cross-regional networks, enabling seamless public safety services globally even where different bands are utilized for public safety. In one or more embodiments, a user device can connect to multiple RF bands simultaneously, allowing for concurrent use of different services on different bands. This multi-registration capability can provide a significant improvement in service delivery and resource utilization.

In one or more embodiments, a communications service provider can offer a public safety service in a different country or region, where the country or region only deploys a RAN network and connects back to the providers Network Core (e.g., FirstNet 5G core). In this example, the FirstNet 5G core would then define or select which RF frequency on the RAN will serve which particular service(s).

One or more embodiments can differentiate between various types of services when assigning frequencies, so that critical or significant services do not share bandwidth with less important applications.

In one or more embodiments, network slicing is performed at a more granular level to provide more efficient use of resources and better performance, including better quality of experience for users. As an example, browser session-level network slicing can be performed. This enables the system to expand URSP policies beyond supporting only application-level network slicing, and provides for network slicing on a mobile browser session level. For instance, each tab or session within a mobile browser can create or utilize a new or different slice (or selectively have the capability to do so), enabling more efficient and tailored use of network resources.

In one or more embodiments, application feature-level network slicing can be performed. As an example, network slicing can be implemented at the level of individual features within a single application. For instance, a chat application that supports audio, video, and messaging services can have different network slices created for each of these features. This ensures that each feature receives the appropriate network resources based on its specific requirements.

In one or more embodiments, the system and methodology can provide an enhanced mobile application layer. For example, a mobile application layer can be enhanced to assign a unique ID to every browser tab and/or application subfunction. This can be achieved through a new API interface that exposes subfunctions to the mobile application layer. In one or more embodiments, the unique ID can be assigned based on predefined tables and/or AI/ML logic that determines or predicts a particular slice for each subfunction. In one embodiment, the slice selection can be based on real-time and/or near-real-time information associated with the network and/or the end user device, including network metrics whereby the selected network slice can provide a performance improvement for the communication service and/or the particular feature of the application providing the communication service.

In one or more embodiments, the system and methodology can provide an enhanced mobile OS/kernel layer. As an example, a mobile OS/kernel layer can be enhanced to map the unique ID assigned by the mobile application layer to a URSP rule route descriptor. This mapping ensures that the appropriate network slice is allocated based on the unique ID.

In one or more embodiments, the system and methodology can provide an API for network operators to feed in predefined rules and/or AI/ML data to the mobile application layer, enabling dynamic and intelligent selection of network slices. One or more of these embodiments enable more precise and efficient allocation of network resources, improving performance and providing tailored experiences for different applications and services, such as in a 5G or NG environment. Other embodiments are described in the subject disclosure.

One or more aspects of the subject disclosure include a non-transitory machine-readable medium, comprising executable instructions that, when executed by a processing system including a processor of an end user device, facilitate performance of operations. The operations can include generating a first unique identifier corresponding to a first feature of an application executed by the end user device; and selecting a first traffic descriptor according to the first unique identifier. The operations can include generating a second unique identifier corresponding to a second feature of the application; and selecting a second traffic descriptor according to the second unique identifier, where the first and second traffic descriptors are used in conjunction with UE Route Selection Policy (URSP) rules to utilize one or more network slices for communication services associated with the first and second features of the application.

One or more aspects of the subject disclosure include an end user device, comprising a processing system including a processor; and a memory that stores executable instructions that, when executed by the processing system, facilitate performance of operations. The operations can include generating unique identifiers corresponding to different applications being executed via browsers of the end user device; and selecting traffic descriptors according to the unique identifiers, where the traffic descriptors are used in conjunction with UE Route Selection Policy (URSP) rules to utilize different network slices for communication services associated with the different applications.

One or more aspects of the subject disclosure include receiving, by a processing system including a processor, a first message indicating a subscription to a first communication service, the first message being received from an end user device; and obtaining, by the processing system, a first Radio Frequency Selection Priority (RFSP) value from a network database, where the first RFSP value is selected from among a group of RFSP values available to the end user device based on the first communication service, and where the group of RFSP values are mapped to different communication services that include the first communication service. The method can include providing, by the processing system, the first RFSP value to the end user device to cause the end user device to scan frequencies according to the first RFSP to provide the first communication service.

In one or more embodiments, the system and methodology can provide a more efficient process for scanning the RF frequency (e.g., when a mobile device connects to the RF network) rather than utilizing a default priority of band order already defined on the device. For example, once the end user device connects to the network, a 5GC/LTE network can use RFSP to send a particular RF priority for connecting going forward (e.g., once the UE goes to idle).

In one or more embodiments, the system and methodology can provide a mechanism to tie an RFSP priority to a particular service and/or region (or nation), which can enable multi-country and regional RF band selection for 5G or NG. For instance, FirstNet is a public safety broadband network, which comes with a dedicated band 14 spectrum. Currently, a Service Profile Identifier (SPID) value allows a setup on band 14 as a priority band for selection for a subscription associated with a public safety service device. However, this can result in all services on that device using band 14 for a particular subscriber, so whether that user watches a streaming service or is making a mission critical call, they are using band 14 and congesting it. In one or more embodiments, the system and methodology allows for a mapping of different network services to RFSP values, such as slice, voice, video, mission critical, and/or FirstNet applications, and requesting a specific RF frequency priority for that particular service. In one or more embodiments, this can save critical RF resources for critical applications for example for band 14 and can put other low priority applications or slices on non-band 14 spectrum like n77, which may have more capacity and will not easily get congested. For example, when a non-mission critical 5QI is requested (e.g., for video application) 5QI 8 can be requested, and a gNB can apply inter-frequency HO/load balancing mechanisms to route the users 5QI 8 traffic to band 66, while a mission critical service using 5QI 65 will continue to work on band 14. Public Safety networks are becoming increasing global, and more and more countries are trying to adopt Public Safety dedicated networks. One or more of the exemplary embodiments allow the ability for a specific service selection across different countries or jurisdictions.

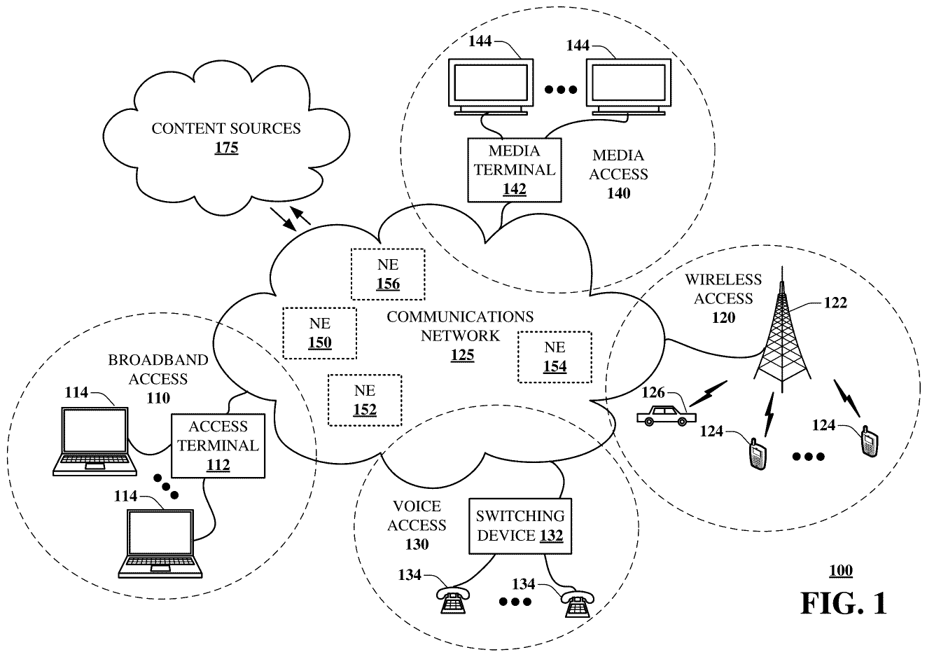

Referring now to FIG. 1, a block diagram is shown illustrating an example, non-limiting embodiment of a system 100 in accordance with various aspects described herein. For example, system 100 can facilitate in whole or in part receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

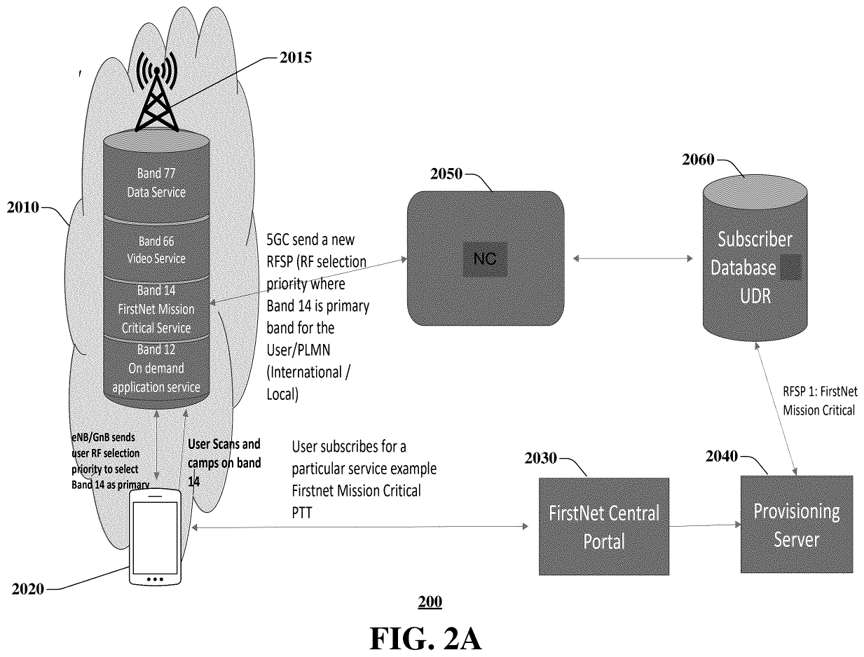

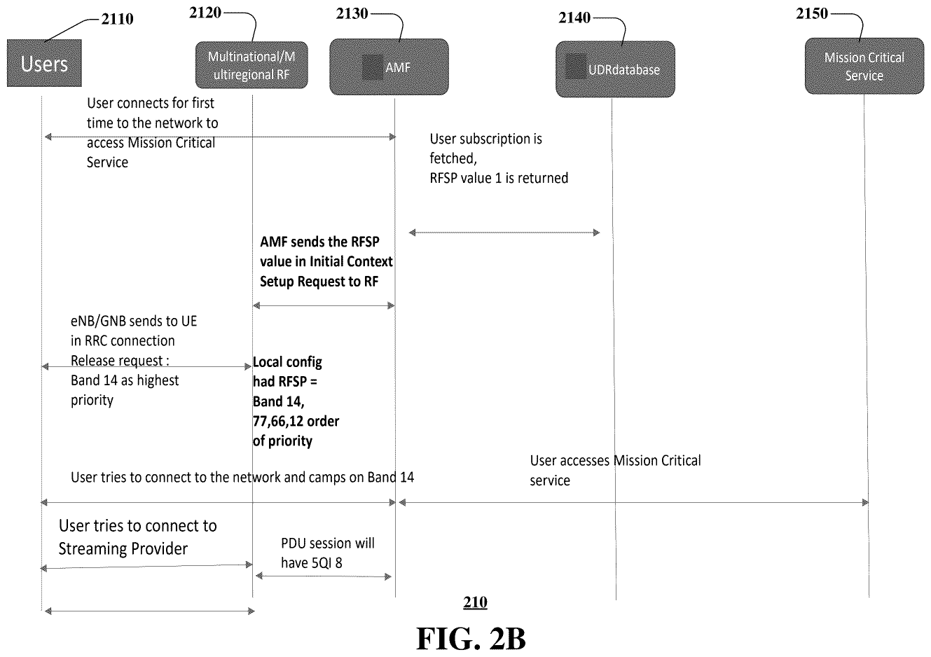

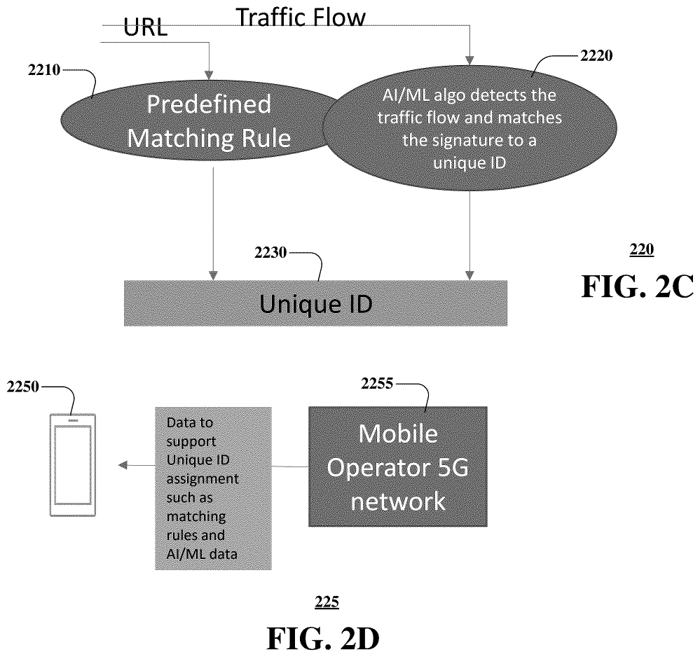

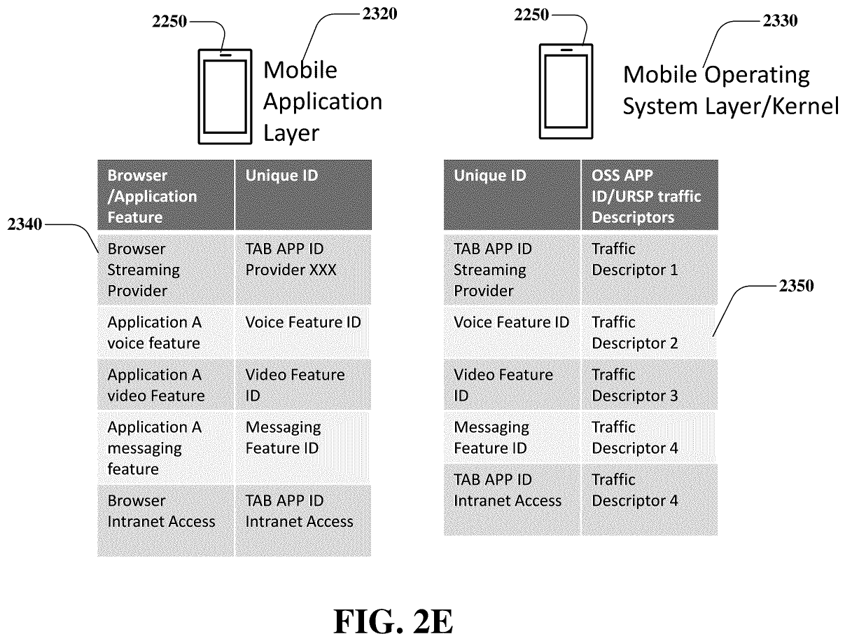

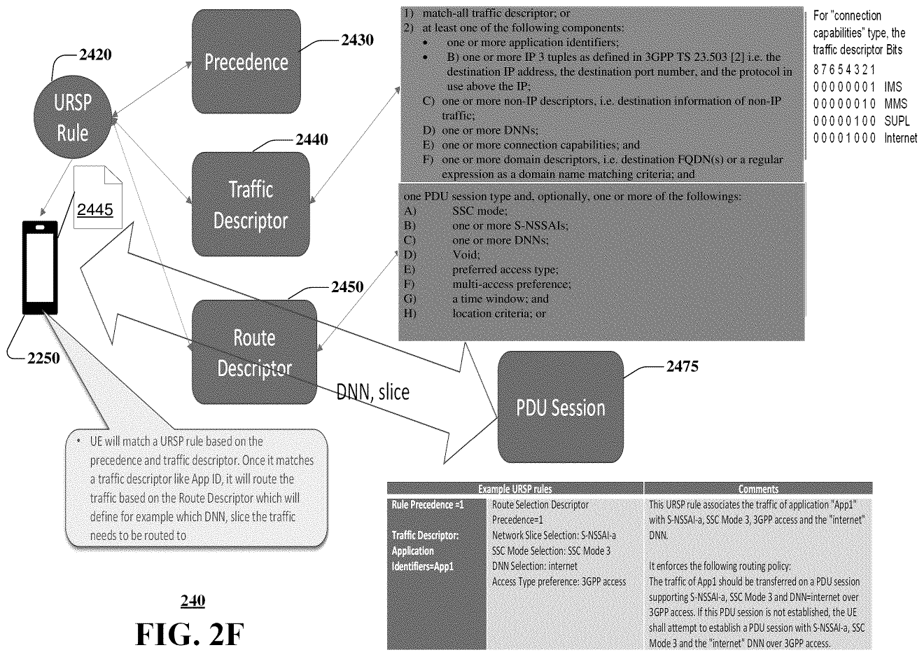

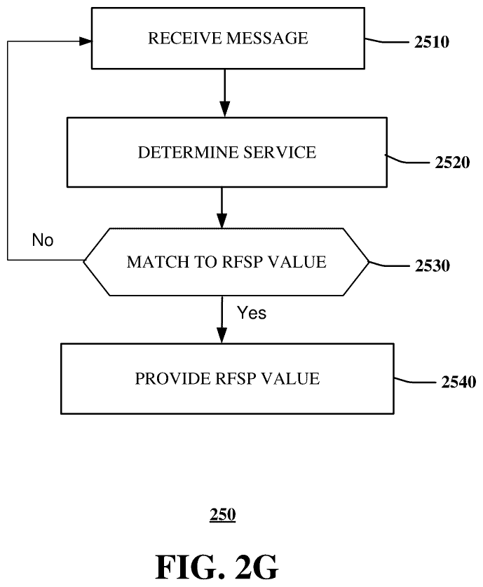

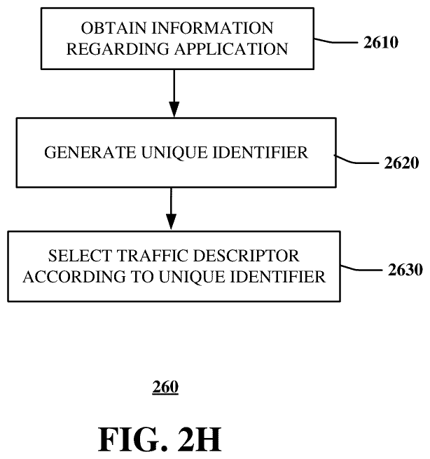

FIG. 2A is a block diagram illustrating an example, non-limiting embodiment of a system 200 functioning within the communication network of FIG. 1 in accordance with various aspects described herein. System 200 enables UE 2020 to provide messaging indicating a subscription to a communication service through use of various network components or elements including a public safety portal 2030 (e.g., FirstNet Central Portal), a provisioning server 2040, a subscriber or other network database 2060 (e.g., UDR database) and/or a network core 2050. These components can be in communication directly or indirectly with a Radio Access Network (RAN) 2010 that can include one or more gNodeBs (gNbs) 2015 (or eNodeBs (eNBs)). This allows for distribution or transmitting of RFSP value(s) such as stored in the UDR database 2060, where the RFSP value can be selected from among a group of RFSP values available to the end user device based on the communication service, the type of communication service, one or more features of the communication service, and/or other factors that allow for intelligently selecting and/or prioritizing frequency bands for delivery of the communication service. In one or more embodiments, the group of RFSP values can be mapped to different communication services that include the communication service being sought by UE 2020. Exemplary bands 77, 66, 14, and 12 are illustrated and mapped to different services such as data, video, MCS, and on-demand applications, however, other bands and other service mapping can be utilized.

System 200 allows a particular RFSP value to be obtained by the UE 2020 according to the communication service being sought so that the UE scans frequencies that provide better performance for the particular communication service and/or based on other factors including managing network load (e.g., reducing congestion on band 14 by removing or otherwise putting non-mission-critical communications on other bands). System 200 also allows this process to be repeated for any number of communication services being sought to enable any number of RFSP values to be obtained which provides for different scanning and different prioritizing of frequencies based on the communication service(s), including when the communication services are to be provided at a same time.

RAN 2010 through use of gNb 2015 can provide data services using band 77 such as for high-capacity data transmission making it more suitable for applications that require significant bandwidth, such as large file transfers, cloud services, and other data-intensive activities. For example, an RFSP value can be provided to prioritize band 77 for data services, ensuring that these services receive the necessary bandwidth and low-latency channels. In this example, a provisioning server can assign an RFSP value to the data service, which the UE 2020 uses to prioritize band 77 for data-related activities.

RAN 2010 through gNb 2015 can provide video services using band 66 such as for video streaming applications, providing the necessary bandwidth and quality of service (QoS) to ensure smooth and uninterrupted video playback. For example, an RFSP value can be provided to prioritize band 66 for a video service, causing the UE 2020 to scan for available RF bands and selecting band 66 based on the assigned RFSP value, ensuring optimal performance for video applications.

RAN 2010 through gNb 2015 can provide mission services using band 14 which can be reserved for public safety communications, offering reliable and low-latency connectivity for first responders and other users. For example, a high-priority RFSP value can be provided to the UE 2020 for the mission services, ensuring that these services are prioritized on band 14. When the user accesses a mission service, the UE 2020 scans for available RF bands and selects band 14 based on the assigned RFSP value, guaranteeing the necessary performance and reliability for communications.

RAN 2010 through gNb 2015 can provide on-demand application services using band 12 which can be used for applications that require moderate bandwidth and can tolerate higher latency, such as certain mobile applications and background data synchronization. For example, an RFSP value can be provided to prioritize band 12 for on-demand applications. When the user accesses an on-demand application, the UE 2020 scans for available RF bands and selects band 12 based on the assigned RFSP value, ensuring efficient use of spectrum resources for these applications.

In the example illustrated in FIG. 2A, the UE 2020 subscribes for a FirstNet Mission Critical PTT resulting in the UE scanning and camping on band 14. When the user attempts to access a mission service, the UE 2020 uses the assigned RFSP value to prioritize band 14. The UE 2020 scans the RF spectrum, detects band 14, and establishes a connection with the network's base station (e.g., gNb 2015) operating on band 14. This process ensures that mission services receive the necessary bandwidth and low-latency channels for reliable communication. However, use of other services by this same UE 2020, such as voice, video or messaging that may not be mission critical, can receive a different RFSP value resulting in use of a different band.

As an example, the FirstNet central portal 2030 can be a centralized management system that oversees the provisioning and management of mission services on the FirstNet network. The FirstNet central portal 2030 can interact with the provisioning server 2040 and the UDR 2060 to assign RFSP values to mission services and store these values in the UDR. In one or more embodiments, the portal can communicate with an AMF (e.g., part of the network core 2050) to retrieve the assigned RFSP values. For instance, the assigned RFSP value can be included in an initial context setup request sent to the UE 2020. This centralized management ensures that mission services are prioritized on the appropriate RF bands, such as band 14.

In one or more embodiments, the provisioning server 2040 can process subscription requests and assign RFSP values based on the type of service requested by the user. When a user subscribes to a specific service, such as mission-push-to-talk, the provisioning server 2040 can assign an appropriate RFSP value and store this information in the UDR 2060. The provisioning server 2040 can interact with the FirstNet central portal 2030 and the network core 2050 (e.g., an AMF) to ensure that the assigned RFSP values are used to prioritize the appropriate RF bands for the requested services.

In one or more embodiments, the network core 2050 can include various components including an AMF as described herein, and can manage the overall network operations including ensuring efficient use of RF spectrum resources. The network core 2050 interacts with the provisioning server 2040, and/or other components such as the FirstNet central portal 2030, the UDR 2060 and the AMF to dynamically assign and reassign RFSP values based on type of service sought, network conditions, and/or service requirements. For example, the network core ensures that high-priority services, such as mission communications, receive the necessary bandwidth and low-latency channels, while less significant services are routed to other RF bands, even for the same UE 2020.

In one or more embodiments, the UDR 2060 can be a database that stores user-specific information, including subscription details and assigned or selectable RFSP values. When a user subscribes to a service, the provisioning server 2040 can store the assigned RFSP value in the UDR 2060. The AMF or other network element of the network core 2050 can retrieve the RFSP value from the UDR 2060 when the user attempts to access the service and can include the RFSP value in a message to the UE 2020, such as in the initial context setup request sent to the UE. The UDR 2060 can ensure that the appropriate RFSP values are used to prioritize the RF bands for the requested services, optimizing or improving the use of spectrum resources and ensuring reliable communication for mission services.

In one or more embodiments, system 200 employs RFSP as a mechanism used in wireless communication networks to determine the priority of different radio frequency bands for a user device. System 200 is not limited to a static RFSP technique (i.e., the priority of the RF bands is predefined and does not change based on the type of service being accessed by the user). In a static RFSP system, when a user device connects to the network, the device scans for available RF bands based on a fixed priority order that is already defined on the device. This priority order does not take into account the specific service the user is trying to access. For example, whether the user is making a mission call or streaming a video, the device will follow the same predefined RF band priority. However, this static approach can lead to inefficiencies in the use of RF spectrum resources. Services, such as Mission Push-to-Talk (MCPTT), may end up sharing the same RF band with less critical services, such as video streaming. This can result in congestion on the RF band, reducing the quality of service for applications. By dynamically assigning RFSP values based on the type of service, even for a same UE, the system 200 can prioritize services on dedicated RF bands, ensuring that these services receive the necessary bandwidth and low-latency channels. Less significant services can be routed to other RF bands, optimizing the use of RF spectrum resources and improving overall network performance.

In one or more embodiments, the UE 2020 scans for available RF bands based on a priority order indicated by the RFSP. For example, this process can include consulting the RFSP for the priority order of RF bands. This priority order determines which RF bands the device attempts to connect to first. When a device, such as a smartphone or a tablet, powers on or attempts to connect to the network for the first time, the device initiates a scan for available RF bands. The device follows the RFSP priority order to determine which RF band to connect to. The device scans the RF spectrum to detect available RF bands. The scanning process involves measuring the signal strength and quality of each RF band within the RFSP priority order. Based on the scan results, the device selects the RF band with priority that meets the minimum signal strength and quality criteria. The device then attempts to establish a connection with the network using the selected RF band. Once the device selects an RF band, the device sends a connection request to the network's base station 2015 (e.g., eNodeB or gNodeB) operating on that RF band. The base station 2015 processes the request and establishes a connection with the device. After the initial connection, the network can assign one or more RFSP values to the device such as based on a service being sought. The RFSP value indicates the priority of different RF bands for the device based on the type of service being accessed. For example, a device accessing a mission service may receive an RFSP value that prioritizes a dedicated RF band, such as band 14. In one embodiment if the device goes idle or if the type of service changes, the network can dynamically reassign the RFSP value to adjust the priority of RF bands. This ensures that the device connects to the appropriate RF band for the current or future service. By following this process, the device ensures that the connection is established on the suitable RF band based on the predefined priority order and the assigned RFSP value. This approach helps optimize the use of RF spectrum resources and ensures that services receive the necessary bandwidth and low-latency channels.

In one or more embodiments, one or more RFSP values of the group of RFSP values are dynamically adjusted based on network conditions. As an example, the dynamic adjustment can be based on AI/ML modeling that includes real-time or near-real-time analysis of various factors including network conditions, devices capabilities, predicted conditions, and so forth. In one or more embodiments, a communication service is associated with a public safety service, and the communication service can be requested in a visited jurisdiction that utilizes a different frequency band for the public safety service as compared to a local jurisdiction associated with the UE 2020.

FIG. 2B is a block diagram illustrating an example, non-limiting embodiment of a data flow 210 functioning within the communication network of FIG. 1 and/or the system 200 of FIG. 2A in accordance with various aspects described herein.

The Users 2110 are the end user devices that connect to the network to access various services. These devices can include smartphones, tablets, and other mobile devices used by individuals or organizations. The Users 2110 initiate subscription requests for specific services, such as MCPTT, and interact with the network components to receive the assigned RFSP values. The Users 2110 scan for available RF bands based on the assigned RFSP values and establish connections with the network's base stations operating on the selected RF bands.

The multinational/multiregional RF subsystem 2120 represents the radio frequency infrastructure that spans across multiple jurisdictions, countries or regions or reaches into other jurisdictions, countries or regions. This component(s) ensures that the RF bands are available for use by the Users 2110, regardless of their geographical or jurisdictional location. The RF subsystem 2120 can interact with an Access and Mobility Management Function (AMF) 2130 to provide the necessary RF bands for the requested services. The RF subsystem 2120 supports the dynamic reassignment of RFSP values to adjust the priority of RF bands based on network conditions and service requirements.

The AMF 2130 is responsible for managing the registration, connection, and/or mobility of the Users 2110 within the network. The AMF 2130 retrieves the assigned RFSP values from the UDR 2140 when the Users 2110 attempt to access specific services. As an example, the AMF 2130 can include the assigned RFSP values in the initial context setup request message sent to the Users 2110, guiding the selection of RF bands for the requested services. The AMF 2130 can also support dual registration capability, allowing the Users 2110 to connect to multiple RF bands simultaneously for concurrent use of different services.

The UDR database 2140 is a database that stores user-specific information, including subscription details and assigned RFSP values. When the Users 2110 subscribe to a service, a provisioning server (e.g., server 2040 of FIG. 2A) stores the assigned RFSP values in the UDR database 2140. The AMF 2130 retrieves the RFSP values from the UDR database 2140 when the Users 2110 attempt to access the service and can include the RFSP values in an initial context setup request sent to the Users 2110. The UDR database 2140 ensures that the appropriate RFSP values are used to prioritize the RF bands for the requested services, optimizing or improving the use of spectrum resources and ensuring reliable communication for mission services.

The Mission Critical Service 2150 is a component(s) that can provide mission communication services to the Users 2110. This component ensures that high-priority services, such as MCPTT, receive the necessary bandwidth and low-latency channels.

The Mission Service 2150 interacts with the AMF 2130 and the UDR database 2140 to assign and retrieve the appropriate RFSP values for mission services. When the Users 2110 access a mission service, the Mission Service 2150 ensures that the RF bands are prioritized based on the assigned RFSP values, guaranteeing the necessary performance and reliability for mission communications.

In one or more embodiments, the UE 2110 obtains an RFSP value through a series of interactions with the network infrastructure. The RFSP value determines the priority of different radio frequency bands for the UE based on the type of service being accessed. For example, when a user subscribes to a specific service, such as MCPTT, the user initiates a subscription request such as through the phone. This request is sent to the network's provisioning server. The provisioning server processes the subscription request and assigns an appropriate RFSP value based on the type of service requested. For example, MCPTT services might be assigned a high-priority RFSP value to ensure they use a dedicated and reliable frequency band. The assigned RFSP value is stored in the UDR 2140, which is a database that holds user-specific information, including subscription details and service priorities. When the user attempts to access the subscribed service, the AMF 2130 retrieves the assigned RFSP value from the UDR 2140. The AMF 2130 is responsible for managing user access and mobility within the network. The AMF 2130 includes the retrieved RFSP value in an Initial Context Setup Request, which is sent to the phone. This request contains the necessary information for the phone to establish a connection with the network. Upon receiving the Initial Context Setup Request, the phone scans for available RF bands based on the assigned RFSP value. The phone prioritizes the RF bands according to the RFSP value, ensuring that the most suitable band for the requested service is selected. The phone selects the RF band with priority as indicated by the RFSP value and attempts to establish a connection with the network's base station (e.g., eNodeB or gNodeB) operating on that RF band. If the phone goes idle or if the type of service changes, the network can dynamically reassign the RFSP value to adjust the priority of RF bands. This ensures that the phone connects to the appropriate RF band for the current service. By following this process, the phone obtains an RFSP value that guides the selection of RF bands, optimizing the use of spectrum resources and ensuring that services receive the necessary bandwidth and low-latency channels.

In one or more embodiments, the AMF 2130 can be responsible for managing the registration, connection, and mobility of the UE 2110 within the network, which can include handling the registration process of the UE when the UE first connects to the network. This involves authenticating the UE 2110, verifying the subscription details, and ensuring that the UE is authorized to access the network services. The AMF 2130 communicates with an Authentication Server Function (AUSF) and a Unified Data Management (UDM) to perform these tasks. The AMF 2130 manages the establishment, maintenance, and release of connections between the UE 2110 and the network. When the UE 2110 initiates a connection request, the AMF 2130 processes the request and coordinates with other network functions, such as the Session Management Function (SMF) and the User Plane Function (UPF), to set up the necessary communication channels. The AMF 2130 also handles the release of connections when the UE no longer needs to communicate with the network.

The AMF 2130 is responsible for managing the mobility of the UE 2110 as the UE moves within the network. This includes tracking the location of the UE 2110, handling handovers between different base stations (e.g., gNodeBs), and ensuring seamless connectivity as the UE moves. The AMF 2130 works with the RAN to facilitate these handovers and maintain the quality of service.

The AMF 2130 supports the SMF in managing the data sessions of the UE 2110. This involves coordinating the setup, modification, and release of data sessions, as well as ensuring that the appropriate Quality of Service (QoS) parameters are applied to each session. The AMF 2130 communicates with the SMF to provide the necessary information for session management.

The AMF 2130 enforces network policies related to access and mobility management. This includes applying policies for network slicing, prioritizing certain types of traffic, and ensuring compliance with regulatory requirements. The AMF 2130 works with the Policy Control Function (PCF) to retrieve and enforce these policies.

The AMF 2130 ensures the security of communication between the UE 2110 and the network. This involves handling encryption and integrity protection for signaling messages, as well as managing security and credentials. The AMF 2130 collaborates with the AUSF and the UDM to perform these security functions.

The AMF 2130 maintains the context information of the UE 2110, including the UE's registration status, location, and session details. This context information is used to manage the UE's connectivity and mobility within the network. The AMF 2130 updates and retrieves this information as needed to provide continuous and reliable service to the UE. By performing these functions, the AMF 2130 ensures that the UE 2110 can access and maintain communication services within the network, providing a seamless and efficient user experience.

In one or more embodiments, the AMF 2130 uses the RFSP value to manage and optimize the connection of the UE to the appropriate RF bands based on the type of service being accessed. The RFSP value helps the AMF 2130 prioritize different RF bands to ensure that services receive the necessary bandwidth and low-latency channels. In one embodiment, the AMF 2130 also supports dual (or multi) registration capability, allowing the UE 2110 to connect to multiple RF bands simultaneously for concurrent use of different services. For example, the UE 2110 can connect to band 14 for MCPTT services and band 66 for video streaming services at the same time. This capability enhances service delivery and resource utilization by enabling the UE 2110 to use different RF bands for different services concurrently. By using the RFSP value(s), the AMF 2130 ensures that the UE 2110 connects to the most suitable RF band for the requested service, optimizing or improving the use of RF spectrum resources and providing a seamless and efficient user experience. The RFSP value helps the AMF 2130 manage the registration, connection, and mobility of the UE 2110 within the network, ensuring that services receive the necessary bandwidth and low-latency channels.

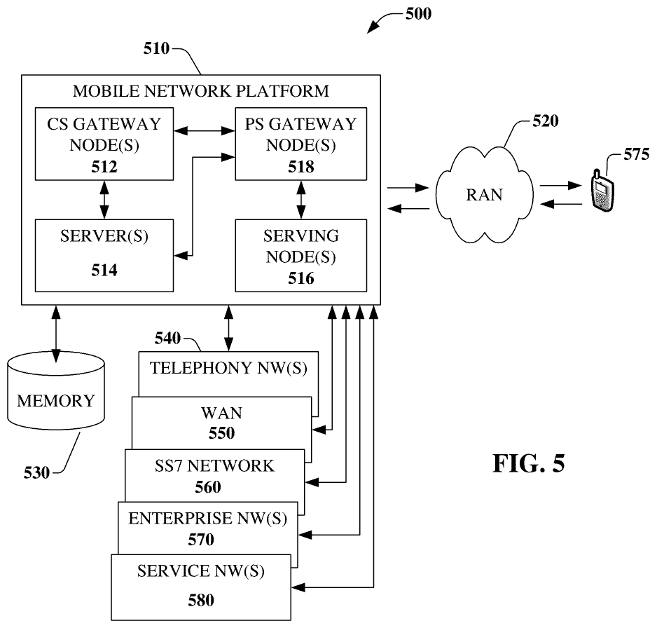

In the context of the system 200 of FIG. 2A and the data flow 210 of FIGS. 2B, 5QI (5G Quality Indicator) plays a role in determining the quality of service (QoS) for different types of network traffic. 5QI values are used to classify and prioritize network services based on their specific requirements, such as latency, reliability, and data rate. 5QI value corresponds to a set of QoS characteristics that ensure the appropriate handling of different types of traffic. For example, a 5QI value of 65 might be assigned to MCPTT services, which require low latency and high reliability. A 5QI value of 8 might be assigned to video streaming services, which can tolerate higher latency but require higher data throughput. As an example, the network core 2050 and the UE 2020 are the primary devices involved in transmitting and receiving 5QI values. For example, when a user subscribes to a particular service, such as MCPTT, the network core 2050 assigns an appropriate 5QI value to that service. This assignment is communicated to the UE 2020, which then uses the 5QI value to determine the priority and handling of the service traffic.

As an example, the user subscribes to a service, such as MCPTT, through the network core 2050 which assigns a 5QI value (e.g., 65 for MCPTT) to the service and stores this information in the UDR 2060. When the user attempts to access the service, the AMF 2130 (see FIG. 2B) retrieves the 5QI value from the UDR 2060 and includes the 5QI value in the Initial Context Setup Request sent to the UE 2020.

The UE 2020 receives the 5QI value and uses the 5QI value to prioritize the service traffic. For instance, the UE 2020 will prioritize MCPTT traffic with 5QI 65 over video streaming traffic with 5QI 8. The RAN 2010 (via gNB 2015) also plays a role in this process by receiving the 5QI values from the UE 2020 and using them to manage radio resources and ensure that high-priority services, such as MCPTT, are allocated the necessary bandwidth and low-latency channels. By dynamically assigning 5QI values based on the type of service, the system 200 ensures that services receive the appropriate level of QoS, while less significant services are routed to other bands, optimizing or improving the use of RF spectrum resources.

FIG. 2C is a block diagram illustrating an example, non-limiting embodiment of data flow 220 functioning within the communication network of FIG. 1 in accordance with various aspects described herein. FIG. 2D is a block diagram illustrating an example, non-limiting embodiment of a system 225 that can apply the data flow 220 and can function within the communication network of FIG. 1 in accordance with various aspects described herein.

System 225 provides for generating unique identifiers 2230 for different applications and/or different features of an application (e.g., being executed via browser(s)) of the end user device 2250. The UE 2250 can select traffic descriptors according to the unique identifiers. The traffic descriptors can be used in conjunction with URSP rules to utilize different network slices provided by the network 2255 (which is illustrated as a 5g network but can be other types of networks including NG networks) for communication services associated with the different applications and/or different features of an application. In one or more embodiments, the UE 2250 can access an API, wherein the generating of unique identifiers is based on information available to the UE via the API.

In one or more embodiments, predefined or dynamic rules (e.g., stored tables) can be applied to information associated with features of the different applications and/or different features of a single application for the selecting of the unique identifiers as illustrated by reference 2210. In one or more embodiments, an Artificial Intelligence (AI) model or algorithm can be applied to information associated with features of the different applications and/or the different features of a single application for the selecting of the unique identifiers as illustrated by reference 2220. In one or more embodiments, the information can include network traffic and/or a URL that can be analyzed for determining the unique identifiers. In one or more embodiments, the information can be provided by the network 2255 to facilitate determining the unique identifiers.

The unique identifiers can be used to support dynamic network slicing where UEs can access and/or manage network resources (e.g., through their mobile browsers) including selecting or creating customized network slices for specific purposes, such as in a 5G or NG environment. This can enable more efficient use of network resources, improve performance, and provide tailored experiences for different applications and services. In one embodiment, system 225 can take advantage of URSP (UE route selection priority), which includes features and/or capabilities described in TS 23.503 and 24.526 (the disclosures of which are hereby incorporated by reference herein), and which provides a procedure on how to allocate multiple slices to a single mobile device and allocate slices to a particular application based on a URSP rule(s).

In one or more embodiments, the generated unique identifiers 2230 can be utilized in conjunction with other route descriptors, such as OS/APPID or DNN.

In one or more embodiments, UE 2250 is not limited to URSP procedures that only support an app level network slicing based on a network connection indicator, which then interacts with 5G core network and assigns a unique slice to a particular application set such as low latency or high bandwidth application category.

In one or more embodiments, system 225 can perform network slicing on a mobile browser session level, where any number of open mobile browser tabs/sessions can create or have access to a new or selected slice. System 225 also allows network slicing on an application feature level, for example one single chat application that supports audio/video/messaging services. For example, different slices can be used or otherwise created for each of the application features such as audio/video and messaging, which can be features of a single application being executed in a browser or otherwise being executed by the end user device 2250.

Referring additionally to FIG. 2E, a block diagram is illustrated of an example, non-limiting embodiment of data 2340, 2350 in an application layer 2320 and an operating system 2330 of the end user device 2250 functioning within the system 225 of FIG. 2D in accordance with various aspects described herein.

In one embodiment, at least two functions in the mobile device 2250 can be enhanced or otherwise adapted. For example, the mobile application layer 2320 can assign every (or selected ones) browser tab and/or application subfunction with a unique ID. For instance, the mobile application layer 2320 can do this by creating a new API interface into the application/browser which exposes sub functions to the mobile application layer. The mobile application layer 2320 can then enable access to a pre-defined table stored by or accessible to the mobile application layer, such as based on a URL being browsed and/or based on an AI/ML analysis that determines or predicts the unique ID, such as based on trained data. An appropriate unique ID can then be assigned, such as by predicting which kind of slice this particular sub function needs or would perform best with. This can also eliminate static action by app developers.

Continuing with this example, the mobile OS/kernel layer 2330 can be enhanced or adapted to now map the unique ID for individual browser-based applications and/or sub features of an application to a URSP rule route descriptor. This can be done in a number of different ways including through use of a pre-defined table and/or utilizing a AI/ML logic to automatically predict the unique ID based on trained data inference and map an appropriate unique ID that was assigned by mobile application layer to a URSP route descriptor.

In one or more embodiments, the mobile application layer 2320 creates a unique ID for each browser/application feature (e.g., voice, video, audio, messaging, etc.) and then passes it on to mobile OS/kernel 2330 which then maps it to a traffic descriptor. An API can also be made available (e.g., to network operators) to feed in predefined rules and/or AI/ML data for facilitating operations of the mobile application layer 2320 to do such a selection of a unique identifier that leads to a traffic descriptor for use in URSP procedures and network slice selections.

The data 2340 in the application layer 2320 can be based on various browser/application features including a particular streaming provider or application features including voice, video, messaging, intranet access, and so forth. The data 2350 in the mobile OS/kernel layer 2330 can be various traffic descriptors which can be mapped to the unique ID of the data 2340. In one or more embodiments, the UE 2250 can have access to an identifier table (e.g., stored locally and/or available in the Cloud), where generating of the unique identifiers is based on information in the identifier table. In one or more embodiments, different applications can include features associated with voice, video, messaging, or a combination thereof, which can be provided with individual network slices or can be grouped together and provided with the network slice(s). In one or more embodiments, a single application can have any number of unique identifiers corresponding to different features of the application. In one or more embodiments, the different features can include at least two of voice, video, or messaging.

FIG. 2F is a block diagram illustrating an example, non-limiting embodiment of a data flow 240 for UE Route Selection Policy management functioning within the communication network of FIG. 1 and/or in conjunction with system 225 of FIG. 2D in accordance with various aspects described herein.

Data flow 240 can implement network slicing in a wireless communication environment. The UE 2250 can receive a URSP rule 2420 which is based on the unique identifiers 2445 that are generated by the UE 2250 in accordance with the processes described herein, such as with respect to data flow 220 of FIG. 2C. The URSP rule 2420 can contain information about the precedence 2430, traffic descriptor 2440, and route descriptor 2450 necessary for network slicing.

As an example, the precedence 2430 determines the order in which the URSP rules are applied, ensuring that higher precedence rules are considered first. The traffic descriptor 2440 includes various components such as application identifiers, IP addresses, and domain names, which help in identifying the type of traffic generated by the application or service. In one or more embodiments, the traffic descriptor 2440 can be matched against the received or accessed URSP rules. The route descriptor 2450 specifies the network slice, DNN, and other parameters required for routing the traffic. The UE 2250 uses this information to determine the appropriate network slice for the traffic. The UE 2250 can establish a PDU session 2475 with the selected network slice(s) and DNN(s). The PDU session 2475 ensures that the traffic is routed according to the URSP rule, providing the necessary quality of service and other network resources required for the specific application or service.

In one or more embodiments, URSP policies, which are selected in accordance with the unique identifiers 2445 as described herein, are enforced through a combination of network and device-level mechanisms. URSP policies allow the network to control how user equipment (e.g., UE 2250) selects and routes traffic based on predefined rules. These policies are defined by the network operator and communicated to the UE, which then enforces them. The enforcement process involves, but is not limited to, the following steps:
URSP policies are defined by the network operator and stored in the network's PCF. These policies specify the conditions under which certain traffic should be routed through specific network slices or DNN). The policies can include various traffic descriptors such as application identifiers, IP addresses, port numbers, and domain names.
The defined URSP policies are communicated to the UE during the registration or session establishment process. This communication is typically done through the AMF and the SMF in the core network. The policies are sent to the UE in the form of URSP rules.
Once the UE receives the URSP rules, it can store them locally. When the UE initiates a data session or application, it matches the traffic against the received URSP rules. The matching process involves checking the traffic descriptors in the URSP rules against the characteristics of the traffic generated by the application or service.
If a match is found, the UE selects the appropriate route based on the URSP rule. This selection involves determining the network slice, DNN, and other parameters specified in the rule. The UE then establishes a PDU session with the selected network slice and DNN, ensuring that the traffic is routed according to the policy.
Once the PDU session is established, the UE routes the traffic through the selected network slice. The network slice provides the necessary quality of service and other network resources required for the specific application or service. The UE continues to enforce the URSP policies for the duration of the session, ensuring that the traffic is handled according to the predefined rules.
The network operator can update the URSP policies as needed. These updates are communicated to the UE through the same mechanisms used for the initial policy communication. The UE then updates its local policy store and enforces the new policies for subsequent traffic.

By enforcing URSP policies, wireless networks can provide differentiated services and optimize the use of network resources. This allows network operators to offer tailored experiences for different applications and services, ensuring that each type of traffic receives the appropriate level of performance and priority.

FIG. 2G depicts an illustrative embodiment of a method 250 in accordance with various aspects described herein for dynamically assigning RFSP values in a wireless communication network. The method 250 can be implemented by various devices such as a provisioning server, a UDR, an AMF and other network components to optimize or improve the use of RF spectrum resources based on the type of service being accessed by a UE. At 2510, the method 250 receives a message. This message may be a subscription request or a service access request from a user equipment. The message contains information about the specific service the user intends to access. At 2520, the method 250 determines the service. In one embodiment, this can include parsing the message to extract relevant service information.

At 2530, the method 250 matches the service to an RFSP value. The identified service can be compared with predefined RFSP values stored in a database. If a match is found, the method proceeds to the next step. If no match is found, the method may loop back to 2520 for further analysis or handling. At 2540, the method 250 provides the RFSP value to the UE. The RFSP value indicates the priority of different RF bands for the service, guiding the UE in selecting the appropriate RF band for connection.

FIG. 2H depicts an illustrative embodiment of a method 260 in accordance with various aspects described herein for performing network slicing in a wireless environment. The method can be implemented by a mobile device and involves several steps to ensure the appropriate network slice is allocated based on predefined rules and descriptors. At 2610, the method 260 begins with obtaining information regarding the application. This information can include details about the application's features, usage patterns, and/or network requirements. At 2620, the method 260 involves generating an identifier based on the obtained application information. The identifier can be created using predefined tables and/or AI/ML logic, which helps in distinguishing different application features and/or browser tabs.

At 2630, the method 260 involves selecting a traffic descriptor according to the identifier. The traffic descriptor can include parameters such as application identifiers, IP addresses, and/or domain names. This selection ensures that the appropriate network slice is allocated based on the identifier.

While for purposes of simplicity of explanation, the respective processes are shown and described as a series of blocks in FIGS. 2G and 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

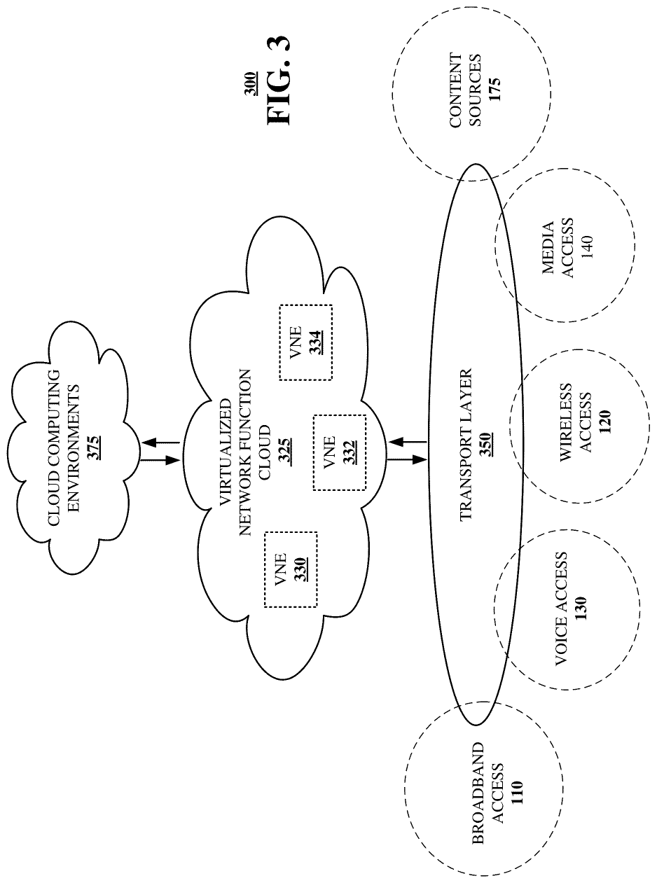

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions described herein. For example, virtualized communication network 300 can facilitate in whole or in part receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

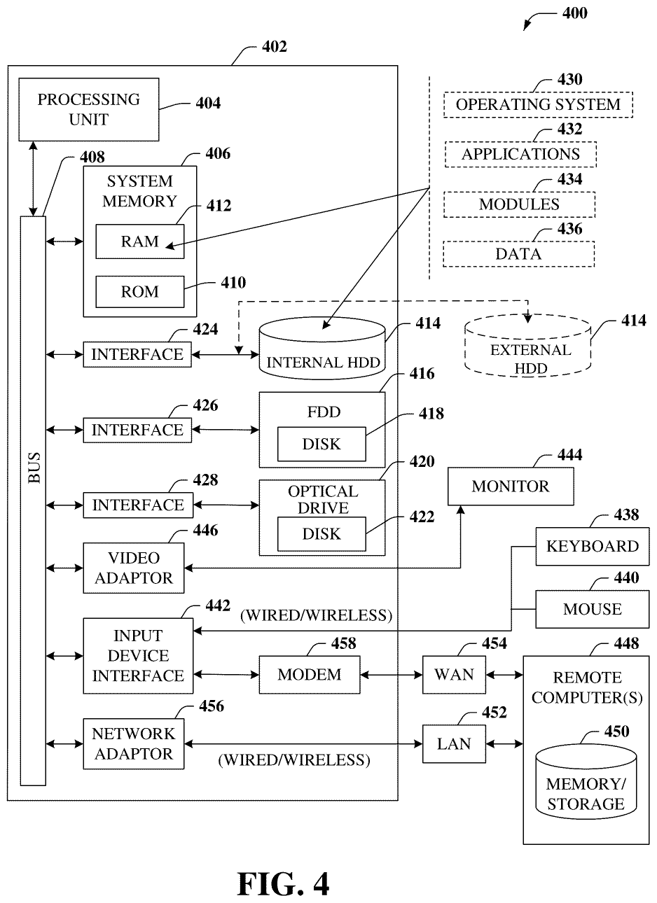

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10 BaseT wired Ethernet networks used in many offices.

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

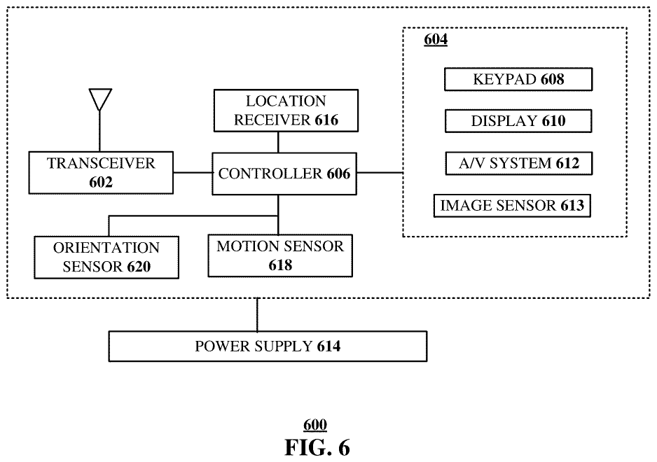

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving messaging indicating a subscription to a communication service from an end user device; obtaining an RFSP value from a network database where the RFSP value is selected from among a group of RFSP values based on the communication service; and providing the RFSP value to the end user device for a priority order for scanning frequencies. Another example includes generating unique identifiers corresponding to different applications and/or different features of an application being executed (e.g., via browser(s)) of the end user device; and selecting traffic descriptors according to the unique identifiers which can be used in conjunction with URSP rules to utilize different network slices for communication services for the end user device.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by a processing system including a processor of an end user device, facilitate performance of operations, the operations comprising:
generating a first unique identifier corresponding to a first feature of an application executed by the end user device;
selecting a first traffic descriptor according to the first unique identifier;
generating a second unique identifier corresponding to a second feature of the application; and
selecting a second traffic descriptor according to the second unique identifier,
wherein the first and second traffic descriptors are used in conjunction with UE Route Selection Policy (URSP) rules to utilize one or more network slices for communication services associated with the first and second features of the application.

2. The non-transitory machine-readable medium of claim 1, wherein the operations further comprise accessing an Application Programming Interface (API), wherein the generating of the first and second unique identifiers is based on information available to the end user device via the API.

3. The non-transitory machine-readable medium of claim 1, wherein the operations further comprise applying an Artificial Intelligence (AI) model to information associated with the first and second features for the selecting of the first and second unique identifiers.

4. The non-transitory machine-readable medium of claim 1, wherein the operations further comprise accessing a stored identifier table, wherein the generating of the first and second unique identifiers is based on information in the stored identifier table.

5. The non-transitory machine-readable medium of claim 1, wherein the first feature is selected from among voice, video, or messaging.

6. The non-transitory machine-readable medium of claim 1, wherein the application is a first application that is being executed via a first browser, and wherein the operations further comprise:
generating a third unique identifier corresponding to a third feature of a second application executed by the end user device via a second browser; and
selecting a third traffic descriptor according to the third unique identifier,
wherein the third traffic descriptor is used in conjunction with the URSP rules to utilize one or more network slices for communication services associated with the third feature of the second application.

7. The non-transitory machine-readable medium of claim 6, wherein the application is a first application that is being executed via a first browser, and wherein the operations further comprise:
generating a fourth unique identifier corresponding to a fourth feature of the second application; and
selecting a fourth traffic descriptor according to the fourth unique identifier,
wherein the fourth traffic descriptor is used in conjunction with the URSP rules to utilize one or more network slices for communication services associated with the fourth feature of the second application.

8. An end user device, comprising:
a processing system including a processor; and
a memory that stores executable instructions that, when executed by the processing system, facilitate performance of operations, the operations comprising:
generating unique identifiers corresponding to different applications being executed via browsers of the end user device; and
selecting traffic descriptors according to the unique identifiers,
wherein the traffic descriptors are used in conjunction with UE Route Selection Policy (URSP) rules to utilize different network slices for communication services associated with the different applications.

9. The end user device of claim 8, wherein the operations further comprise accessing an Application Programming Interface (API), wherein the generating of unique identifiers is based on information available to the end user device via the API.

10. The end user device of claim 8, wherein the operations further comprise applying an Artificial Intelligence (AI) model to information associated with features of the different applications for the selecting of the unique identifiers.

11. The end user device of claim 8, wherein the operations further comprise accessing a stored identifier table, wherein the generating of the unique identifiers is based on information in the stored identifier table.

12. The end user device of claim 8, wherein the different applications include features associated with voice, video, messaging, or a combination thereof.

13. The end user device of claim 8, wherein a first application of the different applications has multiple unique identifiers corresponding to different features of the first application.

14. The end user device of claim 13, wherein the different features include at least two of voice, video, or messaging.

15. A method, comprising:
receiving, by a processing system including a processor, a first message indicating a subscription to a first communication service, the first message being received from an end user device;
obtaining, by the processing system, a first Radio Frequency Selection Priority (RFSP) value from a network database, wherein the first RFSP value is selected from among a group of RFSP values available to the end user device based on the first communication service, wherein the group of RFSP values are mapped to different communication services that include the first communication service; and
providing, by the processing system, the first RFSP value to the end user device to cause the end user device to scan frequencies according to the first RFSP to provide the first communication service.

16. The method of claim 15, comprising:
receiving, by the processing system, a second message indicating another subscription to a second communication service, the second message being received from the end user device;
obtaining, by the processing system, a second RFSP value from the network database, wherein the second RFSP value is selected from among the group of RFSP values available to the end user device based on the second communication service, wherein the different communication services mapped to the group of RFSP values include the second communication service; and
providing, by the processing system, the second RFSP value to the end user device to cause the end user device to scan frequencies according to the second RFSP to provide the second communication service.

17. The method of claim 16, wherein the processing system operates as an Access and Mobility Management Function (AMF).

18. The method of claim 16, wherein the network database operates as a Unified Data Repository (UDR).

19. The method of claim 16, wherein one or more RFSP values of the group of RFSP values are dynamically adjusted based on network conditions.

20. The method of claim 16, wherein the first communication service is associated with a public safety service, and wherein the first communication service is being requested in a visited jurisdiction that utilizes a different frequency band for the public safety service as compared to a local jurisdiction associated with the end user device.
